(19) United States
(12) Patent Application Publication
(10) Pub. No.: US 2006/0209734 A1
(43) Pub. Date: Sep. 21, 2006

(54) System and method for allocating and indicating ranging region in a broadband wireless access communication system

(75) Inventors: Yeong-Moon Son, Anyang-si (KR); Chang-Hoi Koo, Seongnam-si (KR); Pan-Yuh Joo, Seoul (KR); Jung-Je Son, Seongnam-si (KR); Jae-Weon Cho, Suwon-si (KR); Hyun-Jeong Kang, Seoul (KR); Young-Ho Kim, Suwon-si (KR); Sung-Jin Lee, Suwon-si (KR); Hyoung-Kyu Lim, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/371,450

(22) Filed: Mar. 9, 2006

(30) Foreign Application Priority Data
Mar. 9, 2005 (KR) 2005-19856
Mar. 18, 2005 (KR) 2005-22008

(51) Int. Cl. H04H 1/00; H04J 3/24

(52) U.S. Cl. 370/312

(57) ABSTRACT

Disclosed is a system and method for allocating and indicating a ranging region in which a base station (BS) allocates and indicates a ranging region in a broadband wireless access (BWA) communication system. The method includes: ranging region allocation and change indication information in a first region of every downlink frame; determining whether to include information necessary for performing ranging in a broadcast message that is broadcast through a second region of every downlink frame according to the ranging region allocation and change indication information; and allocating a ranging region in an uplink frame according to the ranging region allocation and change indication information.

### PRIORITY

This application claims the benefit under 35 U.S.C. §119(a) to an application entitled “System and Method for Allocating and Indicating Ranging Region in a Broadband Wireless Access Communication System” filed in the Korean Intellectual Property Office on Mar. 9, 2005 and assigned Serial No. 2005-19856, and to an application entitled “System and Method for Allocating and Indicating Ranging Region in a Broadband Wireless Access Communication System” filed in the Korean Intellectual Property Office on Mar. 16, 2005 and assigned Serial No. 2005-22008, the contents of both of which are incorporated herein by reference.

### BACKGROUND OF THE INVENTION

1. Field of the Invention

The present invention relates generally to a Broadband Wireless Access (BWA) communication system, and in particular, to a system and method for allocating and indicating ranging regions in a BWA communication system employing an Orthogonal Frequency Division Multiplexing (OFDM) scheme.

2. Description of the Related Art

Active research into the 4^{th} Generation (4G) communication system, which is the next generation communication system, is being conducted to provide users with services having various Qualities-of-Service (QoSs) that guarantee a data rate of about 100 Mbps. The current 3^{rd} Generation (3G) communication system supports a data rate of about 384 Kbps in an outdoor channel environment having a poor channel condition, and supports a data rate of 2 Mbps at best in an indoor channel environment having a good channel condition.

The Institute of Electrical and Electronics Engineers (IEEE) 802.16 communication system is defined as a system that performs a ranging operation between a subscriber station (SS) and a base station (BS) to achieve communication. Rangings used in the IEEE 802.16 communication system include an initial ranging, a maintenance ranging (or periodic ranging), and a bandwidth request ranging. These rangings will now be described.

(1) Initial Ranging

The initial ranging is needed for synchronization acquisition between a mobile subscriber station (MSS) and a BS, and is performed to adjust a correct time offset between the MSS and the BS and to adjust a transmission power. That is, upon power-on, the MSS receives information broadcast from the BS to acquire synchronization with the BS, and then performs the initial ranging to adjust the time offset and the transmission power with the BS.

(2) Periodic Ranging

The periodic ranging is periodically performed by the MSS to adjust a channel condition with the BS after adjusting the time offset and transmission power with the BS through the initial ranging.

(3) Bandwidth Request Ranging

The bandwidth request ranging is performed by the MSS to request bandwidth allocation to perform actual communication with the BS after adjusting the time offset and transmission power with the BS through the initial ranging.

FIG. 1 is a block diagram schematically illustrating a configuration of a conventional IEEE 802.16 communication system.

Before a description of FIG. 1 is given, it should be noted that the IEEE 802.16 communication system includes a BWA communication system using an Orthogonal Frequency Division Multiplexing (OFDM) scheme or an Orthogonal Frequency Division Multiple Access (OFDMA) scheme. The IEEE 802.16 communication system transmits physical channel signals using multiple sub-carriers, enabling high-speed data transmission.

Referring to FIG. 1, the IEEE 802.16 communication system has a multi-cell structure, i.e., has a cell 100 and a cell 150, and includes a BS 110 for managing the cell 100, a BS 140 for managing the cell 150, and a plurality of MSSs 111, 113, 130, 151, and 153. The signal exchange between the BSs 110 and 140 and the MSSs 111, 113, 130, 151, and 153 is achieved using the OFDM/OFDMA scheme.

The OFDMA scheme transmits data through sub-carriers or sub-channels. The term “sub-channel” refers to a channel comprised of a plurality of sub-carriers. In a communication system using the OFDMA scheme (hereinafter referred to as an OFDMA communication system”), a predetermined number of sub-carriers constitute one sub-channel and the number of sub-carriers is determined according to system conditions.

FIG. 2 is a graph illustrating a frame structure for an OFDMA communication system. Referring to FIG. 2, a horizontal axis represents OFDMA symbol numbers and a vertical axis represents sub-channel numbers. One OFDMA frame includes a plurality of, for example, 8 OFDMA symbols, and one OFDMA symbol includes a plurality of, for example, N sub-channels. Every OFDMA frame has a ranging channel, and one ranging channel includes a plurality of ranging slots. The ranging channel includes one or more sub-channels, and unique numbers of sub-channels constituting the ranging channel are included in an uplink MAP (UL_MAP) message.

Reference numeral 201 represents a ranging region, i.e., ranging slots, existing in a frame #M, and reference numeral 202 represents ranging slots existing in a frame #(M+1). A ranging slot for sending a ranging signal exists only for an uplink interval. The information indicating whether the ranging slot exists for an uplink interval is also included in the UL_MAP message. In other words, the UL_MAP message, which is broadcast every frame, includes therein information indicating a presence and/or absence of the ranging slot, meaning that the ranging slot can be optionally included in each individual frame. A detailed description thereof will be made below.

FIG. 3 is a diagram illustrating a downlink frame structure for a BWA communication system employing an OFDM/OFDMA scheme. In particular, the downlink frame shown in FIG. 3 is a downlink frame structure corresponding to an IEEE 802.16a or IEEE 802.16e communication system.

Referring to FIG. 3, the downlink frame includes a preamble region 300, a broadcast control region 310, a plurality of Time Division Multiplexing (TDM) regions 320, and a Time Division Multiple Access (TDMA) region 330. The preamble region 300 is provided to transmit a synchronization signal, i.e., a preamble sequence, for acquiring synchronization between a BS and an MSS.

The broadcast control region 310 includes a Frame Control Header (FCH) region 315, a downlink MAP (DL_MAP) region 311, and an uplink MAP (UL_MAP) region 313. The FCH region 315 is provided for transmission of Downlink Frame Prefix (DLFP) information. A format of the DLFP is shown in Table 1 below.

TABLE 1

| | | |
|---|---|---|
| Syntax | Size | Notes |

DL_Frame_Prefix_Format( ) {

| Used subchannel bitmap | 6 bits | Bit #0: Subchannels |
|---|---|---|
| | | 0-11 are used |
| | | Bit #1: Subchannels |
| | | 12-19 are used |
| | | Bit #2: Subchannels |
| | | 20-31 are used |
| | | Bit #3: Subchannels |
| | | 32-39 are used |
| | | Bit #4: Subchannels |
| | | 40-51 are used |
| | | Bit #5: Subchannels |
| | | 52-59 are used |
| Ranging_Change_Indication | 1 bit | |
| Repetition_Coding_Indication | 2 bits | 00: No repetition coding |
| | | on DL_MAP |
| | | 01: Repetition coding |
| | | of 2 used on DL_MAP |
| | | 10: Repetition coding |
| | | of 4 used on DL_MAP |
| | | 11: Repetition coding |
| | | of 6 used on DL_MAP |
| Coding_Indication | 3 bits | 0b000 - CC encoding |
| | | used on DL_MAP |
| | | 0b001 - BTC encoding |
| | | used on DL_MAP |
| | | 0b010 - CTC encoding |
| | | used on DL_MAP |
| | | 0b011 - ZT CC used |
| | | on DL_MAP |
| | | 0b100 to 0b111 - |
| | | Reserved |
| DL_MAP_Length | 8 bits | |
| reserved | 4 bits | Shall be set to zero |

}

As shown in Table 1, the DLFP includes a plurality of Information Elements (IEs) of a Used Subchannel bitmap IE indicating the number of groups of sub-channels used in a Partial Usage Sub Channel (PUSC) zone of a downlink frame, a Ranging Change Indication IE indicating a change in allocation of a ranging region for periodic ranging or bandwidth request ranging of an MSS through comparison with a previous frame, a Repetition Coding Indication IE indicating repetition coding indication used for the DL_MAP, a Coding Indication IE indicating a modulation and coding method used for transmission of the DL_MAP, and a DL_MAP_Length IE indicating a length of the DL_MAP.

The DL_MAP region 311 is provided for transmission of a DL_MAP message, and IEs included in the DL_MAP message are shown in Table 2 below.

TABLE 2

| Syntax | | Size | Notes |
|---|---|---|---|
| DL_MAP_Message_Format( ) { | | | |
| | Management Message Type=2 | 8 bits | |
| | PHY Synchronization Field | variable | See appropriate |
| | | | PHY specification |
| | DCD Count | 8 bits | |
| | Base Station ID | 48 bits | |
| | Number of DL_MAP Elements n | 16 bits | |
| | Begin PHY Specific Section { | | See applicable |

| | PHY section |
|---|---|
| for (i=1; i<=n; i++) { | For each DL_MAP |

| | | Element 1 to n |
|---|---|---|
| DL_MAP_Information_Element( ) | variable | See corresponding |
| | | PHY specification |

if !(byte boundary) {

| | | |
|---|---|---|
| Padding Nibble | 4 bits | Padding to reach |

byte boundary

}

}

}

}

As shown in Table 2, the DL_MAP message includes a plurality of IEs of a Management Message Type IE indicating a type of the transmission message, a physical (PHY) Synchronization IE established according to a modulation and demodulation schemes applied to a physical channel for synchronization acquisition, a Downlink Channel Descript (DCD) count IE indicating a count corresponding to a change in configuration of a DCD message including a downlink burst profile, a Base Station ID IE indicating a Base Station Identifier, and a Number of DL_MAP Elements n IE indicating the number of elements following the Base Station ID.

The UL_MAP region 313 is provided for transmission of a UL_MAP message, and IEs included in the UL_MAP message are shown in Table 3 below.

TABLE 3

| | | |
|---|---|---|
| Syntax | Size | Notes |

| UL_MAP_Message_Format( ) { | | |
|---|---|---|
| | Management Message | 8 bits |
| Type=3 | | |
| | Uplink Channel ID | 8 bits |
| | UCD Count | 8 bits |
| | Allocation Start Time | 32 bits |

| | |
|---|---|
| Begin PHY Specific Section | See applicable PHY |

| { | | section |
|---|---|---|
| | for (i=1; i<=n; i++) { | For each UL_MAP |

| | | element 1 to n |
|---|---|---|
| UL_MAP_IE( ) | variable | See corresponding |

PHY specification

}

}
if !(byte boundary) {

| | | |
|---|---|---|
| Padding Nibble | 4 bits | Padding to reach |

byte boundary

}

}

As shown in Table 3, the UL_MAP message includes a plurality of IEs of a Management Message Type IE indicating a type of the transmission message, an Uplink Channel ID IE indicating an Uplink Channel ID in use, an Uplink Channel Descript (UCD) count IE indicating a count corresponding to a change in configuration of a UCD message including an uplink burst profile, and a plurality of UL_MAP IEs indicating size/position/attribute of each data burst constituting a downlink frame. Herein, the Uplink Channel ID is uniquely allocated in a Media Access Control (MAC)_sublayer.

A format of the UL_MAP IE is shown in Table 4 below.

TABLE 4

| Syntax | Size | Notes |
|---|---|---|
| UL_MAP_IE( ) { | | |
| CID | 16 bits | |
| UIUC | 4 bits | |

if (UIUC==12) {

| | | |
|---|---|---|
| OFDMA Symbol offset | 8 bits | |
| Subchannel offset | 7 bits | |
| No.OFDMA Symbols | 7 bits | |
| No.Subchannels | 7 bits | |
| Ranging Method | 2 bits | 0b00 - Initial |

| | | Ranging over |
|---|---|---|
| | | two symbols |
| | | 0b01 - Initial |
| | | Ranging over |
| | | four symbols |
| | | 0b10 - BW |
| | | Request/Periodic |
| | | Ranging over |
| | | one symbol |
| | | 0b11 - BW |
| | | Request/Periodic |
| | | Ranging over |
| | | three symbols |
| reserved | 1 bit | Shall be set |
| | | to zero |

} else if (UIUC==14) {

| | |
|---|---|
| CDMA_Allocation_IE( ) | 32 bits |

} else if (UIUC==15) {

| | | |
|---|---|---|
| Extended UIUC | variable | See clauses |

| dependent IE | following |
|---|---|
| | 8.4.5.4.3 |

} else {

| Duration | 10 bits | In OFDMA slots |
|---|---|---|
| | | (see 8.4.3.1) |
| Repetition coding | 2 bits | 0b00 - No |

| indication | | | repetition |
|---|---|---|---|
| | | | coding |
| | | | 0b01 - |
| | | | Repetition |
| | | | coding of |
| | | | 2 used |
| | | | 0b10 - |
| | | | Repetition |
| | | | coding of |
| | | | 4 used |
| | | | 0b11 - |
| | | | Repetition |
| | | | coding of |
| | | | 6 used |
| | } | | |
| | Padding nibble, if needed | 4 bits | Competition |

to nearest
byte, shall
be set to 0.

}

As shown in Table 4, the UL_MAP IE includes a Connection ID indicating an MSS that uses an uplink data burst, an Uplink Interval Usage Code (UIUC) used for distinguishing a type of the UL_MAP IE, and different IEs corresponding to the UIUC values. For example, for UIUC=12, the UL_MAP IE is used by an MSS for indicating resource allocation information necessary for ranging to a BS, i.e., for indicating position, size and attribute of an uplink frame. In other words, a UL_MAP IE with UIUC=12 indicates a start point of a ranging region using OFDMA Symbol offset (indicating a distance from the start of a corresponding frame in units of OFDMA symbols) and Subchannel Offset (indicating a distance from Subchannel 0 in units of Subchannel Indexes) shown in Table 4. Further, the UL_MAP IE with UIUC=12 indicates ranging resource allocation region information using No. OFDMA Symbols (indicating the number of symbols in a data burst) and No.Subchannel (indicating the number of Subchannel indexes). In addition, using Ranging Method, the UL_MAP IE with UIUC=12 indicates whether an allocated ranging region is for initial ranging or bandwidth request/periodic ranging.

As described above, the UL_MAP message can include therein two ranging regions, i.e., a ranging region for initial ranging (Ranging Method=0b00 or 0b01) and a ranging region for bandwidth request/periodic ranging (Ranging Method=0b10 or 0b11). In addition, the UL_MAP message may not include therein the UL_MAP IE with UIUC=12. In this case, the MSS cannot attempt ranging in an uplink frame not including the UL_MAP IE with UIUC=12, and can perform ranging in an uplink frame including therein the UL_MAP IE with UIUC=12.

UL_MAP IEs with UIUC=1 to UIUC=11 each include a size (Duration in units of OFDMA slots) of data bursts used for Fast_Feedback Channel, data transmission of MSS and indicating an end of the UL_MAP region, and a Repetition coding Indication field in use. The UL_MAP IEs with UIUC=1 to UIUC=11 are mapped to Uplink Channel Description (UCD) messages indicating modulation/coding methods and physical characteristics for their associated bursts, on a one-to-one basis. That is, the UCD message includes an uplink burst profile. Therefore, the MSS must have the UCD information before receiving the UL_MAP message and decoding the received UL_MAP message.

If the MSS fails in successfully performing ranging, it determines a random backoff value to increase a success rate in the next ranging attempt, and makes a ranging attempt again after a lapse of the backoff time. Information necessary for determining the backoff value is also included in a UCD message shown in Table 5 below.

TABLE 5

| | | |
|---|---|---|
| Syntax | Size | Notes |

| UCD_Message_Format( ) { | |
|---|---|
| Management Message Type=0 | 8 bits |
| Uplink channel ID | 8 bits |

| | |
|---|---|
| Configuration Change Count | 8 bits |
| Mini-slot size | 8 bits |
| Ranging Backoff Start | 8 bits |
| Ranging Backoff End | 8 bits |
| Request Backoff Start | 8 bits |
| Request Backoff End | 8 bits |
| TVL Encoded Information for | Variable |

the overall channel

Begin PHY Specific Section {

for(i=1: i<n; i+n)

| | |
|---|---|
| Uplink_Burst_Descriptor | Variable |

}

}

As show in Table 5, the UCD message includes a plurality of IEs of a Management Message Type IE indicating a type of the transmission message, an Uplink Channel ID IE indicating an uplink channel ID in use, a Configuration Change Count IE indicating a Configuration Change Count counted in a BS, a Mini-slot Size IE indicating a size of mini-slots of an uplink physical channel, a Ranging Backoff Start IE indicating a start point of a backoff for initial ranging (i.e., a size of an initial backoff window for initial ranging), a Ranging Backoff End IE indicating an end point of a backoff for the initial ranging (i.e., a size of a final backoff window), a Request Backoff Start IE indicating a start point of a backoff for contention data and requests (i.e., a size of an initial backoff window), and a Request Backoff End IE indicating an end point of a backoff for contention data and requests (i.e., a size of the final backoff window).

In addition, the TMD region 320 and the TDMA region 330 are mapped to the time slots allocated to each individual MSS on a TDM/TDMA basis. The BS transmits necessary broadcast information to the MSSs through the DL_MAP region 311 of the downlink frame using a predetermined center carrier.

Upon power-on, the MSS monitors the full frequency band to detect a pilot channel signal having the highest power, i.e., the highest pilot carrier-to-interference and noise ratio (CINR). The MSS determines a BS, a pilot channel signal received from which has the highest pilot CINR, as its current BS, and analyzes the DL_MAP region 311 and the UL_MAP region 313 of the downlink frame transmitted from the BS, to detect control information for controlling its own uplink and downlink and information indicating actual data transmission/reception points.

FIG. 4 is a diagram illustrating an uplink frame structure for a BWA communication system employing an OFDM/OFDMA scheme. In particular, the uplink frame shown in FIG. 4 is an uplink frame structure corresponding to an IEEE 802.16a/e communication system. Referring to FIG. 4, the uplink frame includes a region 400 for initial ranging, a region 410 for maintenance ranging, i.e., bandwidth (BW) request/periodic ranging, and SS scheduled data regions 420 including uplink data of MSSs.

The initial ranging region 400 has a UL_MAP IE with UIUC=12 and Ranging Method=0b00 or 0b01. The BW request/periodic ranging region 410 has a UL_MAP IE with UIUC=12 and Ranging Method=0b10 or 0b11. The initial ranging region 400 and the BW request/periodic ranging region 410 can coexist in one uplink frame, and the BS can either allocate the ranging regions 400 and 410 to frames, or not allocate the ranging regions 400 and 410 to the frames according to circumstances.

The initial ranging region 400 has a plurality of access burst intervals actually including initial ranging and periodic ranging, and a collision interval if a collision occurs between the access burst intervals.

The BW request/periodic ranging region 410 has a plurality of bandwidth request intervals actually including bandwidth request ranging, and a collision interval if a collision occurs between the bandwidth request intervals.

The SS scheduled data region 420 includes a plurality of SS scheduled data zones of SS#1 scheduled data zone through SS#N scheduled data zone. A SS scheduled data is allocated to the remaining regions except for the initial ranging region 400 and the BW request/periodic ranging region 410 after the initial ranging region 400 or the BW request/periodic ranging region 410 is allocated in the uplink frame. This is because the SS scheduled data region, as described with reference to Table 4, is allocated a UL_MAP IE with UIUC=1 to UIUC=11, but its size is determined based on a size (Duration in units of OFDMA slots) of a data burst of the UL_MAP IE.

As described above, the information on the SS scheduled data region includes only the size information of the SS scheduled data region based on only the UL_MAP IE. Therefore, the MSS must determine whether the UL_MAP message includes therein a UL_MAP IE with UIUC=12 indicating the initial ranging region 400 or the BW request/periodic ranging region 410. If the UL_MAP message includes the UL_MAP IE with UIUC=12, the MSS recognizes ranging regions allocated by the UL_MAP IE and then recognizes SS scheduled data zones sequentially allocated to the remaining regions except for the above ranging regions in the uplink frame.

However, if the UL_MAP message does not include the UL_MAP IE with UIUC=12, the MSS recognizes that there is no ranging region allocated by the UL_MAP IE. Therefore, the MSS recognizes that the SS scheduled data zones, a number of which corresponds to a size (Duration in units of OFDMA slots) of the data burst, were sequentially allocated beginning at the start point of the full uplink frame.

FIG. 5 is a flow diagram schematically illustrating a communication procedure in a BWA communication system. Referring to FIG. 5, upon power-on, an MSS 520 monitors a full frequency band previously allocated thereto to detect a pilot channel signal having the highest power, i.e., the highest pilot CINR. The MSS 520 determines a BS 500, a pilot channel signal received from which has the highest pilot CINR, as its current BS 500, and receives a preamble of the downlink frame transmitted by the BS 500 to acquire system synchronization with the BS 500.

If the system synchronization is acquired between the MSS 520 and the BS 500, the BS 500 transmits a DL_MAP message and a UL_MAP message to the MSS 520 in steps 511 and 513.

To perform ranging to the BS 500, the MSS 520 transmits a ranging code to the BS 500 in step 515. Upon receiving the ranging code, the BS 500 transmits a Ranging Response (RNG RSP) message to the MSS 520 in step 517. The MSS 520 may transmit a Ranging Request (RNG_REQ) message instead of the ranging code. However, compared with performing the ranging using the ranging code, performing the ranging using the RNG_REQ message may increase a ranging collision probability between MSSs. Therefore, the IEEE 802.16a/IEEE 802.16e communication system employing the OFDMA scheme uses the method of transmitting the ranging code in a dedicated interval for ranging so as to previously prevent the collision, especially to efficiently perform the initial ranging.

The ranging region is allocated according to the UL_MAP IE with UIUC=12 in the UL_MAP message. The MSS can be aware of the position and size of the ranging region in the uplink frame by receiving and analyzing the UL_MAP IE. The ranging region can be allocated every uplink frame, and the position or size of the ranging region occupied in the uplink frame is not subject to frequent change. Nevertheless, after receiving the downlink frame, the MSS must always check the UL_MAP IE with UIUC=12 in the UL_MAP message even though a value of a Ranging_Change_Indication field in DLFP information is 0, i.e., even though there is no change in the position or size of the ranging region. Including the UL_MAP IE with UIUC=12 in the UL_MAP message of every downlink frame is overhead. For example, for the message broadcast from the BS to the MSS, a decrease in size of the message contributes to an increase in data burst region through which data can be actually transmitted, thereby increasing the bandwidth transmission efficiency.

In addition, the BS applies the most robust modulation and coding method to a broadcast message such as a UL_MAP or DL_MAP message in order to transmit the broadcast message to the MSS farthest therefrom. This serves as a limitation in the possible amount of actual transmission data because the modulation and coding method is applied such that a ratio of the overhead to the actual data is high.

### SUMMARY OF THE INVENTION

It is, therefore, an object of the present invention to provide a ranging region allocation system and method for reducing system overhead in a BWA communication system.

It is another object of the present invention to provide a system and method for indicating a ranging region allocated to reduce system overhead in a BWA communication system.

According to one aspect of the present invention, there is provided a method for allocating and indicating a ranging region by a base station (BS) in a broadband wireless access (BWA) communication system. The method includes the steps of including ranging region allocation and change indication information in a first region of every downlink frame and determining whether to include information necessary for performing ranging in a broadcast message that is broadcast through a second region of every downlink frame according to the ranging region allocation and change indication information.

According to another aspect of the present invention, there is provided a method for performing ranging by a mobile subscriber station (MSS) in a broadband wireless access (BWA) communication system. The method includes the steps of receiving ranging region allocation and change indication information included in a first region of every downlink frame; determining whether to read information necessary for performing ranging from a broadcast message that is broadcast through a second region of every downlink frame according to the ranging region allocation and change indication information; recognizing a ranging region of an uplink frame according to the determination result; and performing ranging through the recognized ranging region.

According to further another aspect of the present invention, there is provided a method for allocating a ranging region and performing ranging by a base station (BS) and a mobile subscriber station (MSS) in a broadband wireless access (BWA) communication system. The method includes the steps of including, by the BS, ranging region allocation and change indication information in a first region of every downlink frame; determining by the BS whether information necessary for performing ranging is included in a broadcast message that is broadcast through a second region of every downlink frame according to the ranging region allocation and change indication information; allocating a ranging region in an uplink frame according to the ranging region allocation and change indication information; transmitting, by the BS, the downlink frame to the MSS; receiving, by the MSS, the ranging region allocation and change indication information included in the first region of every downlink frame; determining by the MSS whether to read information necessary for performing ranging from a broadcast message that is broadcast through the second region of every downlink frame according to the ranging region allocation and change indication information; recognizing, by the MSS, a ranging region of an uplink frame according to the determination result; and performing, by the MSS, ranging through the recognized ranging region.

According to yet another aspect of the present invention, there is provided a system for allocating a ranging region and performing ranging between a base station (BS) and a mobile subscriber station (MSS) in a broadband wireless access (BWA) communication system. The system includes the BS for including ranging region allocation and change indication information in a first region of every downlink frame, determining whether information necessary for performing ranging is included in a broadcast message that is broadcast through a second region of every downlink frame according to the ranging region allocation and change indication information, allocating a ranging region in an uplink frame according to the ranging region allocation and change indication information, and transmitting the downlink frame to the MSS; and the MSS for receiving from the BS the ranging region allocation and change indication information included in the first region of every downlink frame, determining whether to read information necessary for performing ranging from a broadcast message that is broadcast through the second region of every downlink frame according to the ranging region allocation and change indication information, recognizing a ranging region of an uplink frame according to the determination result, and performing ranging through the recognized ranging region.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram schematically illustrating a configuration of a conventional IEEE 802.16 communication system;

FIG. 2 is a graph illustrating a frame structure for an OFDMA communication system;

FIG. 3 is a diagram illustrating a downlink frame structure for a BWA communication system employing an OFDM/OFDMA scheme;

FIG. 4 is a diagram illustrating an uplink frame structure for a BWA communication system employing an OFDM/OFDMA scheme;

FIG. 5 is a flow diagram schematically illustrating a communication procedure in a BWA communication system employing an OFDM/OFDMA scheme;

FIG. 6 is a diagram illustrating a frame structure for a description of an exemplary ranging region allocation and indication scheme according to the present invention;

FIGS. 7A and 7B are flowcharts illustrating a process of allocating and indicating an initial ranging region and a BW request/periodic ranging region according to the present invention; and

FIGS. 8A to 8C are flowcharts illustrating a process of recognizing a ranging region and performing the corresponding ranging in an MSS according to the present invention.

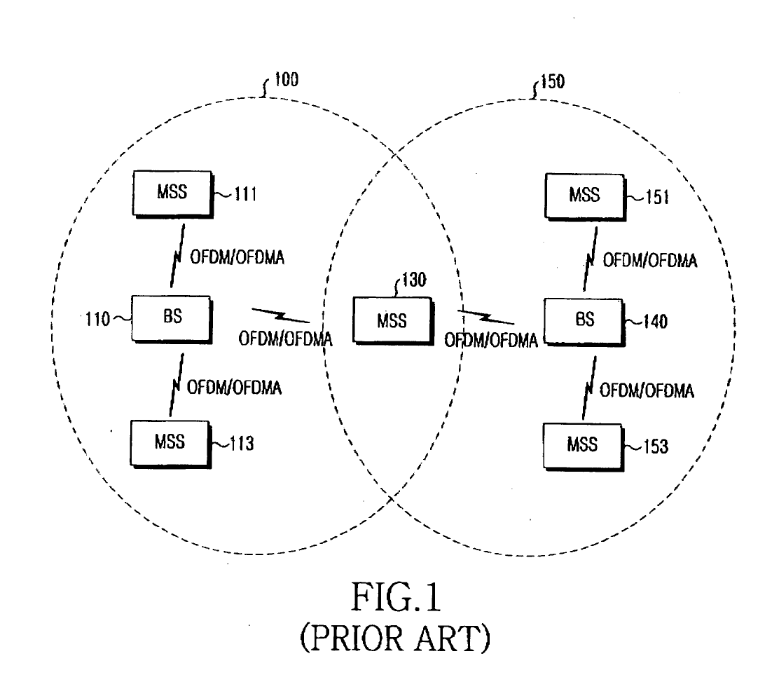

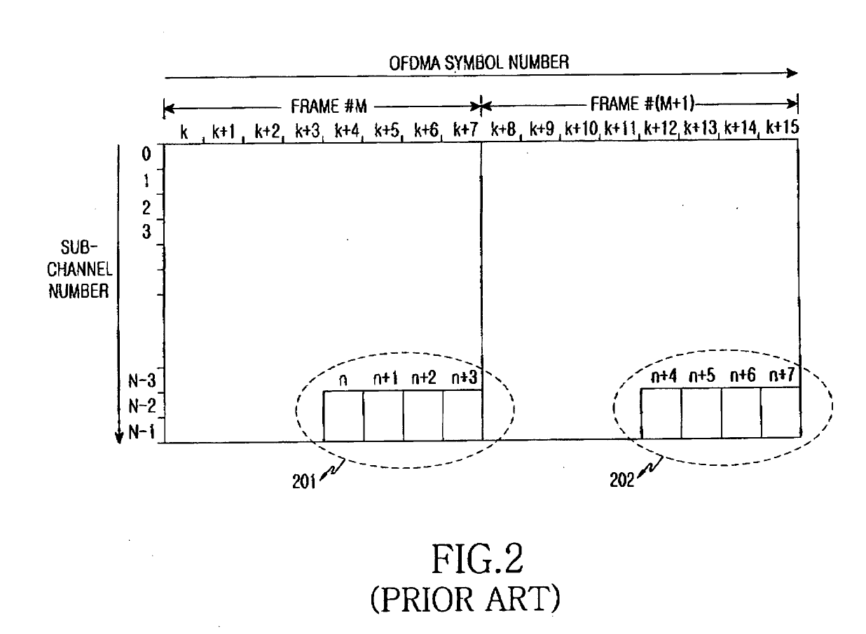

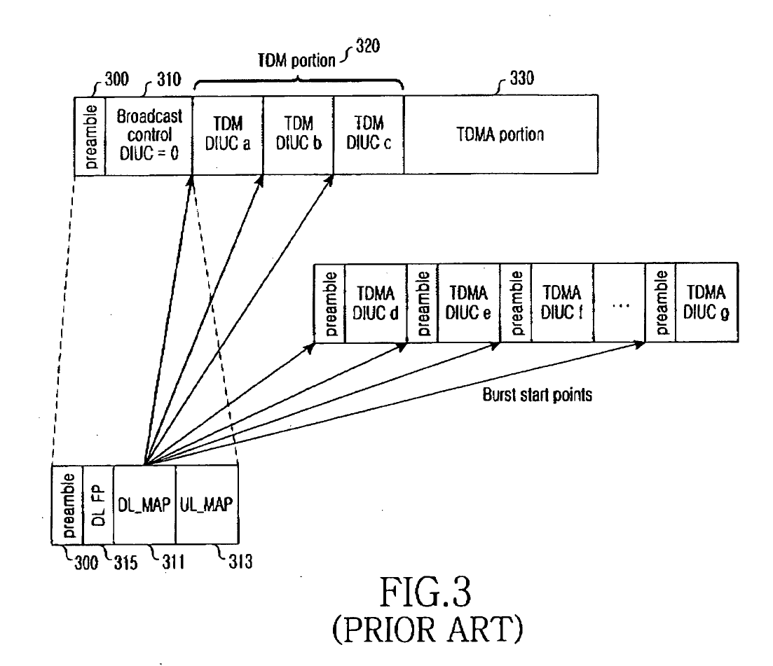

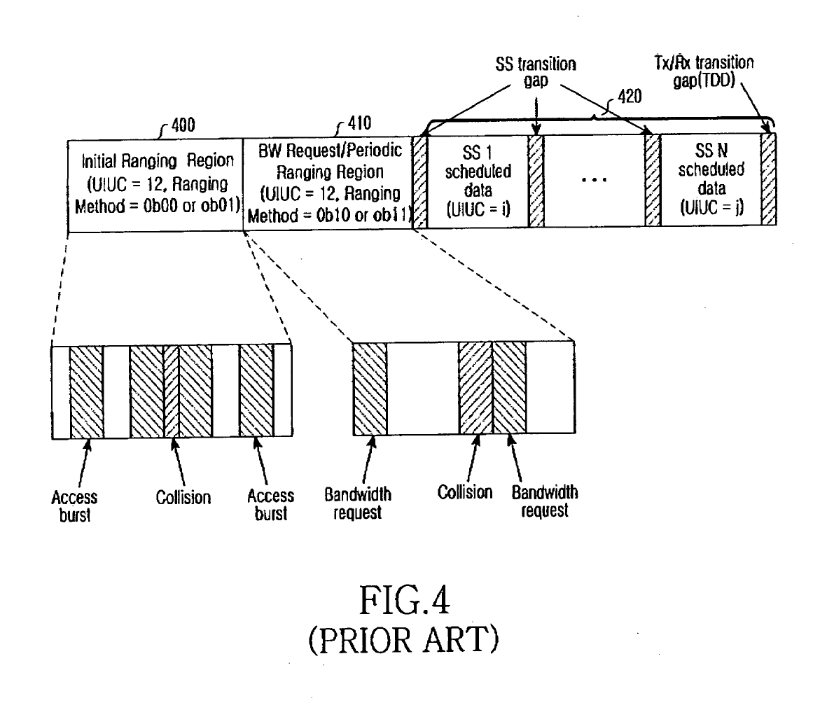

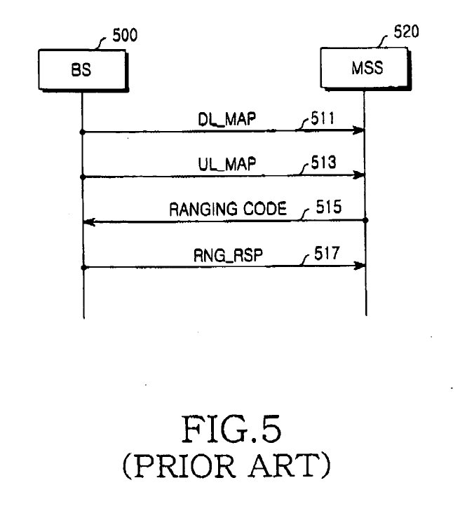

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a scheme for reducing a size of an uplink MAP (UL_MAP) message in a communication system employing an Orthogonal Frequency Division Multiple Access (OFDMA) scheme. In first, second and third embodiments of the present invention, a base station (BS) can delete a UL_MAP IE with UIUC=12 from the UL_MAP message before transmitting the UL_MAP message to a mobile subscriber station (MSS). Alternatively, the BS can include the UL_MAP IE in the UL_MAP message before transmission, as described with reference to Table 4.

### First Embodiment

The MSS performs a ranging operation even when the BS transmits a UL_MAP message not including the UL_MAP IE with UIUC=12 and the MSS receives the UL_MAP message. Therefore, the present invention changes a format of a Downlink Frame Prefix (DLFP) of a downlink frame so that the MSS can perform the ranging operation even when the BS transmits a UL_MAP message not including the UL_MAP IE with UIUC=12.

Downlink Frame Prefix (DLFP)

The DLFP is transmitted through a Frame Control Header (FCH) region. A format of the DLFP proposed in the present invention is shown in Table 6 below.

TABLE 6

| Syntax | Size | Notes |
|---|---|---|
| DL_Frame_Prefix_Format ( ) { | | |
| Used subchannel bitmap | 6 bits | Bit #0: Subchannels |
| | | 0-11 are used |
| | | Bit #1: Subchannels |
| | | 12-19 are used |
| | | Bit #2: Subchannels |
| | | 20-31 are used |
| | | Bit #3: Subchannels |
| | | 32-39 are used |
| | | Bit #4: Subchannels |
| | | 40-51 are used |
| | | Bit #5: Subchannels |
| | | 52-59 are used |
| Repetition_Coding_Indication | 2 bits | 00 - No repetition |
| | | coding on DL_MAP |
| | | 01 - repetition coding |
| | | of 2 used on DL_MAP |
| | | 10 - repetition coding |
| | | of 4 used on DL_MAP |
| | | 11 - repetition coding |
| | | of 6 used on DL_MAP |
| Coding_Indication | 3 bits | 0b000 - CC encoding used |
| | | on DL_MAP |
| | | 0b001 - BTC encoding used |
| | | on DL_MAP |
| | | 0b010 - CTC encoding used |
| | | on DL_MAP |
| | | 0b011 - ZT CC used on |
| | | DL_MAP |
| | | 0b100 to 0b111 - Reserved |
| DL_MAP_Length | 8 bit | |
| UL_MAP IE Existence for Initial | 1 bit | |
| Ranging | | |
| Allocation or Change for Initial | 1 bit | |
| Ranging | | |
| UL_MAP IE Existence for BW | 1 bit | |
| Request/Periodic Ranging | | |
| Allocation or Change for BW | 1 bit | |
| Request/Periodic Ranging | | |
| Reserved } | 3 bits | |

As shown in Table 6, in the DLFP of the present invention, the present invention uses the 4 reserved bits in the conventional DLFP format shown in Table I for each of a UL_MAP IE Existence for Initial Ranging field indicating the presence of an initial ranging region, an Allocation or Change for Initial Ranging field indicating allocation or change in the initial ranging region, a UL_MAP IE Existence for BW Request/Periodic Ranging field indicating the presence of a BW request/periodic ranging region, and an Allocation or Change for BW Request/Periodic Ranging field indicating allocation or change in the BW request/periodic ranging region. In addition, the 1 bit for the Ranging_Change_Indication field in the conventional DLFP format will replace 1 reserved bit.

A detailed description will now be made of the 4 fields newly added in the DLFP format.

1. UL_MAP IE Existence for Initial Ranging: This field indicates the presence of a UE_MAP IE defining an initial ranging region in the UL_MAP message. If its value is ‘0’, the field indicates the absence of the UL_MAP IE for the initial ranging region in the UL_MAP message, and if its value is ‘1’, the field indicates the presence of the UL_MAP IE for the initial ranging region in the UL_MAP message.

2. Allocation or Change for Initial Ranging: A use of this field varies according to a value of the UL_MAP IE Existence for Initial Ranging. That is, a value ‘0’ or ‘1’ of the Allocation or Change for Initial Ranging given when a value of the UL_MAP IE Existence for Initial Ranging is ‘0’ or ‘1’, differs in meaning.

When a value of the UL_MAP IE Existence for Initial Ranging is ‘0’, a value of the Allocation or Change for Initial Ranging indicates whether the initial ranging region is allocated in the uplink frame. That is, when the value of the Allocation or Change for Initial Ranging is ‘0’, it means that the initial ranging region is not allocated in the uplink frame. However, if the value is ‘1’, it means that the initial ranging region is allocated in the uplink frame.

However, when the value of the UL_MAP IE Existence for Initial Ranging is ‘1’, the value of the Allocation or Change for Initial Ranging indicates whether there is a change in position or size of the initial ranging region between an initial ranging region of an uplink frame at a previous time and an initial ranging region of an uplink frame at the present time. That is, if the value of the Allocation or Change for Initial Ranging is ‘0’, the field means that there is no difference between a position or size of the initial ranging region existing in the uplink frame at the present time and a position or size of the initial ranging region existing in the uplink frame at the previous time.

If the value of the UL_MAP IE Existence for Initial Ranging is ‘1’ and the value of the Allocation or Change for Initial Ranging is ‘0’, an MSS attempting initial ranging can attempt the initial ranging by receiving a UL_MAP message including a UL_MAP IE with UIUC=12 and Ranging Method=0b00 or 0b01. After completion of the initial ranging, the MSS, as it has initial ranging region information, reads a value ‘0’ of the Allocation or Change for Initial Ranging field in the DLFP format and recognizes that there is no need to decode the UL_MAP IE with UIUC=12 and Ranging Method=0b00 or 0b01. Therefore, compared with the conventional MSS that unconditionally decodes the UL_MAP IE, the novel MSS can reduce a load caused by the signal processing.

However, if the value of the Allocation or Change for Initial Ranging is ‘1’, the field means that there is a change in the position or size of the initial ranging region. Therefore, all MSSs decode the UL_MAP IE for an update of new initial ranging region information.

3. UL_MAP IE Existence for BW Request/Periodic Ranging: This field is similar to the UL_MAP IE Existence for Initial Ranging field, with a difference being that the UL_MAP IE Existence for Initial Ranging field is for the initial ranging while the UL_MAP IE Existence for BW Request/Periodic Ranging field is for the BW request/periodic ranging.

That is, the UL_MAP IE Existence for BW Request/Periodic Ranging field indicates whether the UL_MAP IE defining the BW request/periodic ranging region exists in the UL_MAP MESSAGE. If its value is ‘0’, the field indicates the absence of the UL_MAP IE for the BW request/periodic ranging region in the UL_MAP message, and if its value is ‘1’, the field indicates the presence of the UL_MAP IE for the BW request/periodic ranging region in the UL_MAP message.

4. Allocation or Change for BW Request/Periodic Ranging: This field is similar to the Allocation or Change for Initial Ranging field, with a difference being that the Allocation or Change for Initial Ranging field is for the initial ranging while the Allocation or Change for BW Request/Periodic Ranging field is for the BW request/periodic ranging.

If a value of the UL_MAP IE Existence for BW Request/Periodic Ranging field is ‘0’, a value of the Allocation or Change for BW Request/Periodic Ranging field indicates whether the BW request/periodic ranging region is allocated in the uplink frame. That is, if the value of the Allocation or Change for BW Request/Periodic Ranging is ‘0’, it means that the BW request/periodic ranging region is not allocated in the uplink frame. However, if the value is ‘1’, it means that the BW request/periodic ranging region is allocated in the uplink frame.

However, if the value of the UL_MAP IE Existence for BW Request/Periodic Ranging is ‘1’, the value of the Allocation or Change for BW Request/Periodic Ranging indicates whether there is a change in position or size of the BW request/periodic ranging region between a BW request/periodic ranging region of an uplink frame at a previous time and a BW request/periodic ranging region of an uplink frame at the present time. That is, if the value of the Allocation or Change for BW Request/Periodic Ranging is ‘0’, the field means that there is no difference between a position or size of the BW request/periodic ranging region existing in the uplink frame at the present time and a position or size of the BW request/periodic ranging region existing in the uplink frame at the previous time.

As described, if the value of the UL_MAP IE Existence for BW Request/Periodic Ranging is ‘1’ and the value of the Allocation or Change for BW Request/Periodic Ranging is ‘0’, an MSS attempting BW request/periodic ranging can attempt the BW request/periodic ranging by receiving a UL_MAP message including a UL_MAP IE with UIUC=12 and Ranging Method=0b10 or 0b11. After completion of the BW request/periodic ranging, the MSS, as it has BW request/periodic ranging region information, reads a value ‘0’ of the Allocation or Change for BW request/periodic Ranging field in the DLFP format and recognizes that there is no need to decode the UL_MAP IE with UIUC=12 and Ranging Method=0b10 or 0b11. Therefore, compared with the conventional MSS that unconditionally decodes the UL_MAP IE, the novel MSS can reduce a load caused by the signal processing.

However, if the value of the Allocation or Change for BW Request/Periodic Ranging is ‘1’, the field means that there is a change in the position or size of the BW request/periodic ranging region. Therefore, all MSSs decode the UL_MAP IE for an update of new BW request/periodic ranging region information.

As described above, according to the present invention, the MSS can perform initial ranging or BW request/periodic ranging even though the UL_MAP message that is broadcast every frame includes therein no information on the initial ranging region or the BW request/periodic ranging region. Therefore, the BS can increase the data transmission efficiency by efficiently managing the UL_MAP IE region that occupies a part of the UL_MAP region in the uplink frame.

A description will now be made of a scheme for allocating and indicating the ranging regions using only the initial ranging-related fields. This is because the initial ranging-related fields are different from the BW request/periodic ranging-related fields.

The scheme for allocating and indicating the initial ranging region can be described for 4 possible combinations. That is, for each of the values ‘0’ and ‘1’ of the UL_MAP IE Existence for Initial Ranging, there are the UL_MAP IE Existence for Initial Ranging with a value ‘0’ and the UL_MAP IE Existence for Initial Ranging with a value ‘1’. This is similar to that of a scheme for allocating and indicating BW request/periodic ranging region. For example, ‘01’ indicates that the value of the UL_MAP IE Existence for Initial Ranging is ‘0’ and the value of the Allocation or Change for Initial Ranging is ‘1’. A description will now be made of each of the combinations (i.e., 00, 01, 10, and 11 as shown below).

The “00” combination indicates that the value of the UL_MAP IE Existence for Initial Ranging is ‘0’ and the value of the Allocation or Change for Initial Ranging is ‘0’.

The UL_MAP IE Existence for Initial Ranging value=“0” indicates the absence of the UL_MAP IE with UIUC=12 and Ranging Method=0b00 or 0b01 defining the initial ranging region in the UL_MAP message. This can be construed again for two different cases. First, there is no initial ranging-related UL_MAP IE in the UL_MAP message because the initial ranging region is not actually allocated in the uplink frame. Second, the UL_MAP IE with UIUC=12 may not be included in the UL_MAP message to reduce a length of the UL_MAP message, even though the initial ranging region is allocated in the uplink frame.

A bit value of the Allocation or Change for Initial Ranging field is used to distinguish between the two cases. That is, for the case ‘00’, because the value of the Allocation or Change for Initial Ranging is ‘0’, it means that the initial ranging region is not allocated in the uplink frame. Therefore, the UL_MAP message has no UL_MAP IE with UIUC=12, and an MSS receiving the UL_MAP message as a first UL_MAP message cannot attempt the initial ranging.

In addition, the MSS receiving the UL_MAP message must recognize that data bursts with UIUC=1 to UIUC=11 are sequentially allocated from the start point of the uplink frame, because there is no initial ranging region in the uplink frame.

The “01” combination indicates that the value of the UL_MAP IE Existence for Initial Ranging is “0” and the value of the Allocation or Change for Initial Ranging is “1”.

This combination means that there is no UL_MAP IE with UIUC=12 in the UL_MAP message, because the value of the UL_MAP IE Existence for Initial Ranging is ‘0’. In addition, this combination means that the initial ranging region is allocated in the uplink frame, because the value of the Allocation or Change for Initial Ranging is

Among the MSSs receiving the UL_MAP message with the UL_MAP IE having the combination ‘01’, an MSS continuously attempting the initial ranging even in the current uplink frame after recognizing initial ranging region information of the previous uplink frame, recognizes that the same initial ranging region as the initial ranging region of the previous frame is allocated even in the current uplink frame. Therefore, the MSS receiving the UL_MAP message with the UL_MAP IE having the combination ‘01’ can perform the initial ranging using the previously recognized initial ranging region information, even without decoding the UL_MAP IE.

The MSS receiving the UL_MAP message with the UL_MAP IE having the combination ‘01’ recognizes the presence of the initial ranging region in the uplink frame, and recognizes that data bursts with UIUC=1 to UIUC=11 are sequentially allocated after the initial ranging.

The UL_MAP IE Existence for Initial Ranging value=‘0’ indicates the absence of the UL_MAP IE with UIUC=12 and Ranging Method=0b00 or 0b01 defining the initial ranging region in the UL_MAP message. This can be construed again for two different cases. First, there is no initial ranging-related UL_MAP IE in the UL_MAP message because the initial ranging region is not actually allocated in the uplink frame. Second, the UL_MAP IE with UIUC=12 may not be included in the UL_MAP message to reduce a length of the UL_MAP message, even though the initial ranging region is allocated in the uplink frame.

The “10” combination indicates that the value of the UL_MAP IE Existence for Initial Ranging is ‘1’ and the value of the Allocation or Change for Initial Ranging is ‘0’.

This combination means that there is a UL_MAP IE with UIUC=12 in the UL_MAP message, because the value of the UL_MAP IE Existence for Initial Ranging is ‘1’. In addition, this combination means that there is no difference in position and size between the initial ranging region of the current uplink frame and the initial ranging region of the previous uplink frame, because the value of the Allocation or Change for Initial Ranging is ‘0’.

Meanwhile, the values ‘0’ and ‘1’ of the Allocation or Change for Initial Ranging for the UL_MAP IE Existence for Initial Ranging value=‘0’ are different in meaning from the values ‘0’ and ‘1’ of the Allocation or Change for Initial Ranging for the UL_MAP IE Existence for Initial Ranging value=‘1’. That is, the values ‘0’ and ‘1’ of the Allocation or Change for Initial Ranging for the UL_MAP IE Existence for Initial Ranging value=‘0’ are used to indicate whether the initial ranging region is allocated in the uplink frame, whereas the values ‘0’ and ‘1’ of the Allocation or Change for Initial Ranging for the UL_MAP IE Existence for Initial Ranging value=‘1’ are used to indicate whether there is a change in position or size between the initial ranging region allocated in the previous uplink frame and the initial ranging region allocated in the current uplink frame.

For example, assume, as in the combination ‘01’, that the initial ranging region information is not included in the UL_MAP message but the initial ranging region is allocated in the uplink frame. If an MSS desiring to attempt the initial ranging in this state receives the UL_MAP message with no initial ranging region information, the MSS cannot determine whether or not the ranging region is allocated, and cannot acquire information on the ranging region. Therefore, for the MSS desiring to attempt network entry through the initial ranging, the BS randomly includes the initial ranging region information in the UL_MAP IE region of the UL_MAP message before transmission periodically or when necessary. In this case, a bit value specified in the DLFP format is ‘10’.

In addition, an MSS previously recognizing the initial ranging region information, rather than the MSS attempting the network entry, recognizes that the initial ranging region of the previous uplink frame is equal in position and size to the initial ranging region of the current uplink frame, upon detecting the DLFP specified with ‘10’. Therefore, the MSS has no need to decode the UL_MAP IE of the UL_MAP message.

The “11” combination indicates that the value of the UL_MAP IE Existence for Initial Ranging is ‘1’ and the value of the Allocation or Change for Initial Ranging is ‘1’.

This combination means that there is a UL_MAP IE with UIUC=12 in the UL_MAP message, because the value of the UL_MAP IE Existence for Initial Ranging is ‘1’. In addition, this combination means that there is a change in position and size between the initial ranging region of the current uplink frame and the initial ranging region of the previous uplink frame, because the value of the Allocation or Change for Initial Ranging is ‘1’. Therefore, all MSSs decode the UL_MAPIE information in the UL_MAP message to perform an update of the initial ranging information.

Combinations of the two parameters of the DL_MAP IE Existence for BW Request/Periodic Ranging and the Allocation or Change for BW Request/Periodic Ranging of a DLFP format for the BW request/periodic ranging are almost similar in content to the foregoing combinations, except that the BW request/periodic ranging replaces the initial ranging.

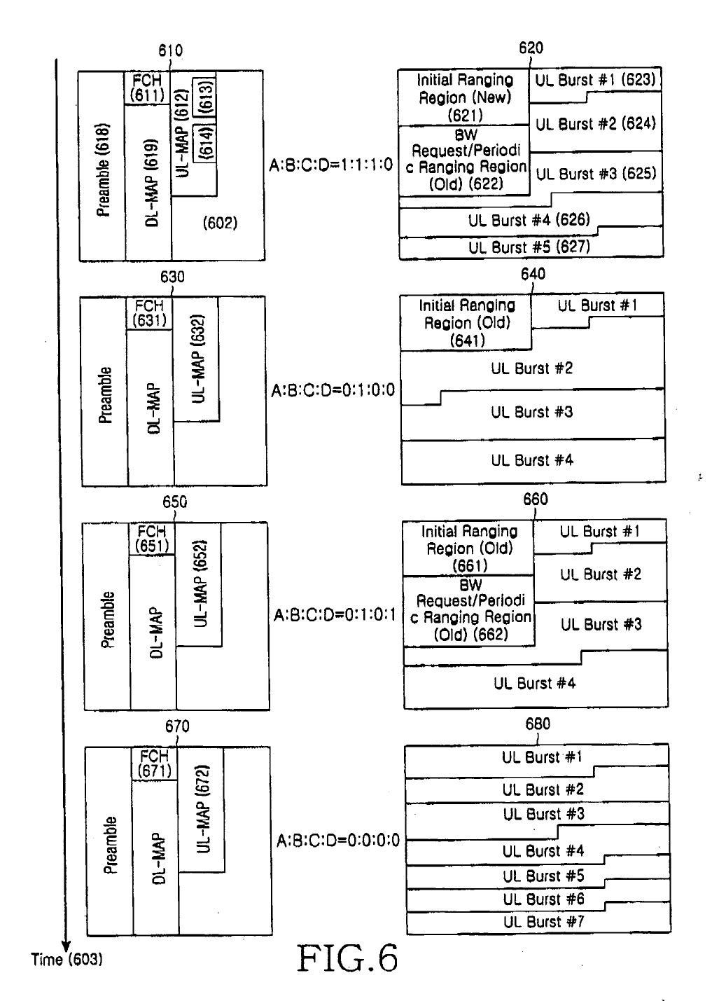

FIG. 6 is a block diagram illustrating a frame structure for a description of an exemplary ranging region allocation and indication scheme according to the present invention. Referring to FIG. 6, the frame can be divided into downlink frame intervals 610, 630, 650, and 670 and uplink frame intervals 620, 640, 660, and 680.

The downlink frames 610, 630, 650, and 670 each include a preamble region 618, an FCH region 611, a DL_MAP region 619, a UL_MAP region 612 and a downlink data burst region 602. The FCH region 611 has therein the DLFP region shown in Table 6. The DLFP region includes therein the UL_MAP IE Existence for Initial Ranging, Allocation or Change for Initial Ranging, UL_MAP IE Existence for BW Request/Periodic Ranging, and Allocation or Change for BW Request/Periodic Ranging fields proposed in the present invention. As represented by reference numerals 615, 633, 653, and 673, the foregoing fields are mapped to A:B:C:D bit values in their order to make a description of an exemplary ranging region allocation and indication scheme. That is, A represents a value of the UL_MAP IE Existence for Initial Ranging, B represents a value of the Allocation or Change for Initial Ranging, C represents a value of the UL_MAP IE Existence for BW Request/Periodic Ranging, and D represents a value of the Allocation or Change for BW Request/Periodic Ranging.

A BS provides ranging region allocation information to MSSs through a DLFP region of the FCH.

A description will first be made of the DLFP region in which A:B:C:D=1:1:1:0 is specified. Referring to the downlink frame 610 and the uplink frame 620, the BS allocates a new initial ranging region 621 in the uplink frame 620, and sets the A:B:C:D bits of the DLFP region to 1:1:1:0 to inform the MSSs that it reallocated the same ranging region 622 as the BW request/periodic ranging region allocated in the previous uplink frame in the current uplink frame 620.

As described above, this means that ‘11’ is given for the initial ranging and ‘10’ is given for the BW request/periodic ranging. That is, this indicates that initial ranging region information is included in a UL_MAP IE of a UL_MAP message, and there is a change in position and size between the initial ranging region of the current uplink frame and the initial ranging region of the previous uplink frame. In addition, it means that BW request/periodic ranging region information is included in the UL_MAP IE of the UL_MAP message, and the BW request/periodic ranging region of the current uplink frame is equal in position and size to the BW request/periodic ranging region of the previous uplink frame.

MSSs recognizing the DLFP in which 1:1:1:0 is specified, may attempt initial ranging, or set a BW request/periodic ranging region using the previously recognized ranging region information and then sequentially allocate uplink data bursts 623, 624, 625, 626, and 627 in a region except for the set ranging region.

A description will now be made of the DLFP region in which A:B:C:D=0:1:0:0 is specified. Referring to the downlink frame 630 and the uplink frame 640, the BS allocates the same initial ranging region 641 as that of the previous uplink frame in the uplink frame 640. However, there is no BW request/periodic ranging region in the uplink frame, and also, there is no UL_MAP IE with UIUC=12 in the UL_MAP message. That is, it can be noted that there is no UL_MAP IE with UIUC=12 included in a UL_MAP region 632 of the uplink frame 30. The BS provides the 0:1:0:0 DLFP in which the above information is specified, to the MSSs through the FCH region 631.

A description will now be made of the DLFP region in which A:B:C:D=0:1:0:1 is specified. Referring to the downlink frame 650 and the uplink frame 660, the BS allocates the same initial ranging region 661 as that of the previous uplink frame in the uplink frame 660. In addition, the BS allocates the same BW request/periodic ranging region 662 as the previous BW request/periodic ranging region in the uplink frame 660. However, it can be noted that a UL_MAP region 652 of the uplink frame 650 includes no UL_MAP IE with UIUC=12. The BS provides the 0:1:0:1 DLFP in which the above information is specified, to the MSSs through the FCH region 651.

Among the MSSs receiving the FCH with the 0:1:0:1 DLFP included therein, an MSS recognizing ranging region information of the previous uplink frame sets an initial ranging region and a BW request/periodic ranging region in the uplink frame 660 and then sequentially allocates uplink data bursts in the remaining regions.

Finally, a description will now be made of the DLFP region in which A:B:C:D=0:0:0:0 is specified. Referring to the uplink frame 670 and the downlink frame 680, the BS does not allocate an initial ranging region and does not allocate a BW request/periodic ranging region in the uplink frame 680. Therefore, there is no UL_MAP IE with UIUC=12 included in the UL_MAP message.

An MSS receiving the FCH with the 0:0:0:0 DLFP included therein, can sequentially allocate uplink data bursts from the start point of the uplink frame 680, recognizing the absence of any ranging region in the uplink frame 680.

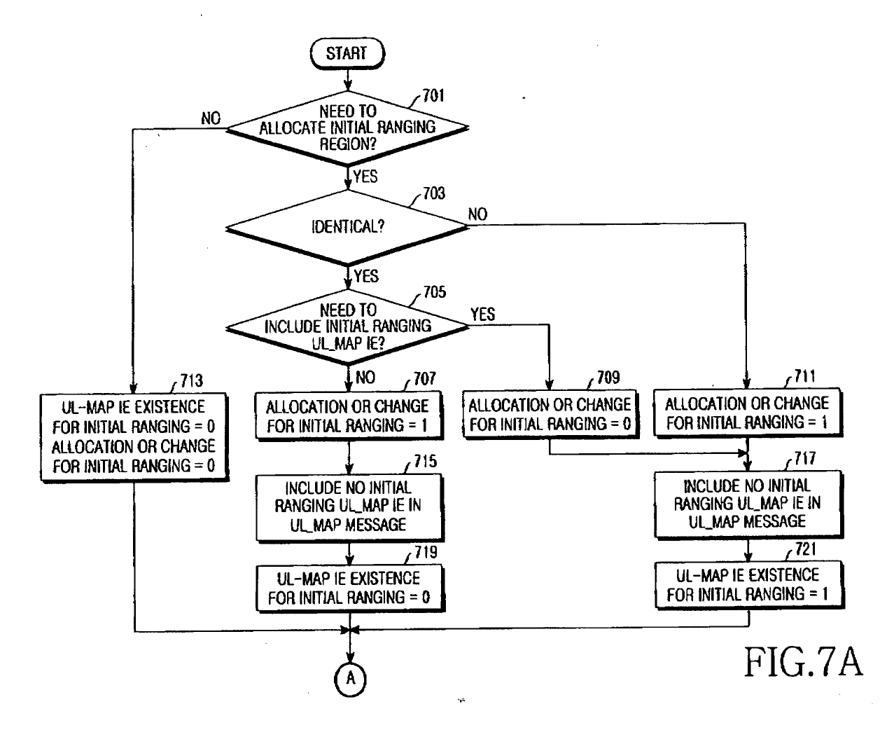

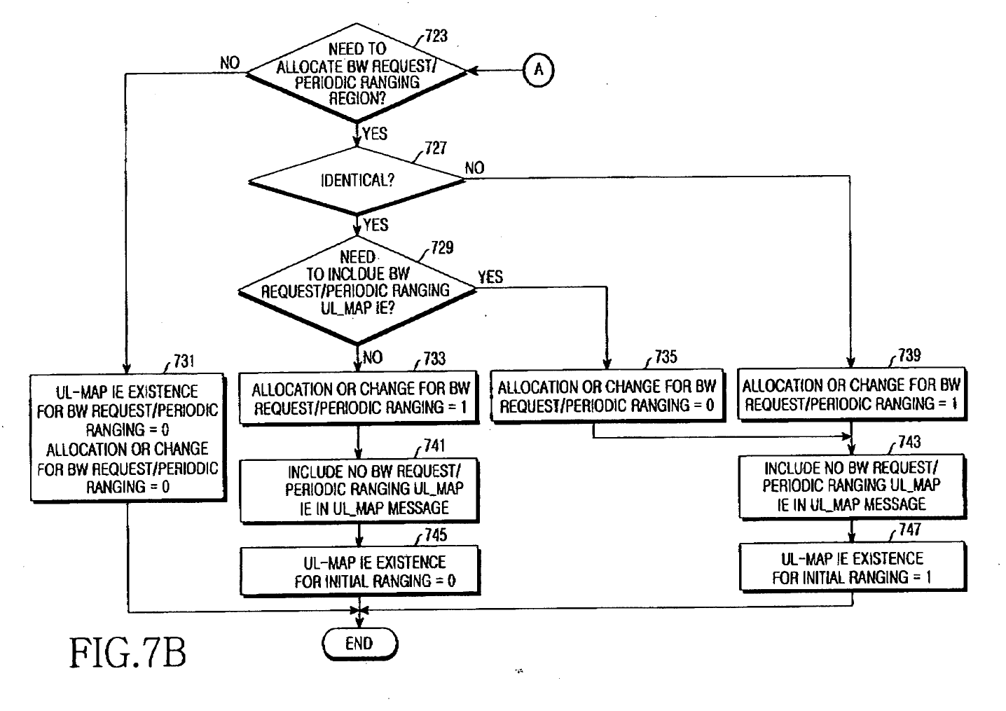

FIGS. 7A and 7B are flowcharts illustrating a process of allocating and indicating an initial ranging region and a BW request/periodic ranging region according to the present invention.

Referring to FIGS. 7A and 7B, a BS determines in step 701 whether to allocate an initial ranging region in the current uplink frame. If the BS determines to allocate the initial ranging region in step 701, it proceeds to step 703. Otherwise, if the BS determines not to allocate the initial ranging region, it proceeds to step 713. In step 713, the BS, because it does not allocate the initial ranging region in the uplink frame, sets both of a UL_MAP IE Existence for Initial Ranging bit and an Allocation or Change for Initial Ranging bit of a DLFP to ‘0’ and then proceeds to step 723 for allocating the BW request/periodic ranging region.

In step 703, the BS determines whether the initial ranging region allocated in the uplink frame is identical to an initial ranging region allocated in the previous uplink frame. If they are identical to each other, the BS proceeds to step 705. Otherwise, if they are not identical to each other, the BS proceeds to step 711. In step 705, the BS determines whether there is a need to include a UL_MAP IE for initial ranging in a UL_MAP message before transmission. This is to determine whether to randomly include initial ranging region information, i.e., a UL_MAP IE for initial ranging (hereinafter referred to as an “initial ranging UL_MAP IE”), in the UL_MAP message periodically or when necessary, for the MSS that fails in recognizing the initial ranging region information. If the BS determines not to include the initial ranging UL_MAP IE in the UL_MAP message, it proceeds to step 707. Otherwise, the BS proceeds to step 709.

In step 707, the BS sets a bit value of the Allocation or Change for Initial Ranging field of the DLFP to ‘1’. This is to inform MSSs that the BW request/periodic ranging region is allocated in the uplink frame. In step 715, the BS includes no initial ranging UL_MAP IE in the UL_MAP message. In step 719, the BS, as it determines not to include the initial ranging UL_MAP IE in the UL_MAP message, sets a bit value of the UL_MAP IE Existence for Initial Ranging of the DLFP to ‘0’, and then proceeds to step 723. Steps 701 through 719 are for an initial ranging bit value of ‘01’. That is, because the current uplink frame includes an initial ranging region and the initial ranging region is equal in position and size to the initial ranging region of the previous uplink frame, no UL_MAP IE for initial ranging is included in the UL_MAP message.

In step 709, the BS sets a bit value of the Allocation or Change for Initial Ranging field of the DLFP to ‘0’. In step 717, the BS includes the UL_MAP IE for initial ranging in the UL_MAP message. In step 721, the BS sets a bit value of the UL_MAP IE Existence for Initial Ranging field of the DLFP information to ‘1’, and then proceeds to step 723. The reason for setting UL_MAP IE Existence for Initial Ranging=1 and Allocation or Change for Initial Ranging=0 is for the MSS that fails in recognizing the initial ranging region information. An MSS previously recognizing the initial ranging region information, rather than the MSS having no initial ranging region information, recognizes that the initial ranging region of the previous uplink frame is equal in position and size to the initial ranging region of the current uplink frame, upon receiving the DLFP information specified with ‘10’. Therefore, the MSS has no need to decode the UL_MAP IE of the UL_MAP message.

In step 711, the BS sets a bit value of the Allocation or Change for Initial Ranging field of the DLFP information to ‘1’. Thereafter, in step 717, the BS includes the UL_MAP IE for initial ranging in the UL_MAP message. In step 721, the BS sets a bit value of the UL_MAP IE Existence for Initial Ranging field of the DLFP information to ‘1’, and then proceeds to step 723. The reason for setting UL_MAP IE Existence for Initial Ranging=1 and Allocation or Change for Initial Ranging=1 is to inform MSSs that there is a change in position and size between the initial ranging region of the uplink frame and the initial ranging region of the previous uplink frame. Therefore, upon receiving the DLFP information, all MSSs decode UL_MAP IE information in the UL_MAP message to perform an update of the initial ranging information.

Steps 723 through 747 are similar to steps 701 through 721, except that the initial ranging replaces BW request/periodic ranging.

In step 723, the BS determines whether to allocate a BW request/periodic ranging region in the current uplink frame. If the BS determines to allocate the BW request/periodic ranging region in step 723, it proceeds to step 727. Otherwise, if the BS determines not to allocate the BW request/periodic ranging region, it proceeds to step 731. In step 731, the BS, as it does not allocate the BW request/periodic ranging region in the uplink frame, sets both of a UL_MAP IE Existence for BW Request/Periodic Ranging bit and an Allocation or Change for BW Request/Periodic Ranging bit of DLFP information to ‘0’.

In step 727, the BS determines whether the BW request/periodic ranging region allocated in the uplink frame is identical to a BW request/periodic ranging region allocated in the previous uplink frame. If they are identical to each other, the BS proceeds to step 729. Otherwise, if they are not identical to each other, the BS proceeds to step 739. In step 729, the BS determines whether there is a need to include a UL_MAP IE for BW request/periodic ranging in a UL_MAP message before transmission. This is to determine whether to randomly include BW request/periodic ranging region information, i.e., a UL_MAP IE for BW request/periodic ranging (hereinafter referred to as a “BW request/periodic ranging UL_MAP IE”), in the UL_MAP message periodically or when necessary, for the MSS that fails in recognizing the BW request/periodic ranging region information. If the BS determines not to include the BW request/periodic ranging UL_MAP IE in the UL_MAP message, it proceeds to step 733. Otherwise, the BS proceeds to step 735.

In step 733, the BS sets a bit value of the Allocation or Change for BW Request/Periodic Ranging field of the DLFP to ‘1’. This is to inform MSSs that the BW request/periodic ranging region is allocated in the uplink frame. In step 741, the BS does not include a BW request/periodic ranging UL_MAP IE in the UL_MAP message. In step 745, the BS, as it determines not to include the BW request/periodic ranging UL_MAP IE in the UL_MAP message, sets a bit value of the UL_MAP IE Existence for BW Request/Periodic Ranging of the DLFP to ‘0’. Steps 723 through 745 are for a BW request/periodic ranging bit value of ‘01’. That is, because the current uplink frame includes a BW request/periodic ranging region and the BW request/periodic ranging region is equal in position and size to the BW request/periodic ranging region of the previous uplink frame, no UL_MAP IE for BW request/periodic ranging is included in the UL_MAP message.

In step 735, the BS sets a bit value of the Allocation or Change for BW Request/Periodic Ranging field of the DLFP information to ‘0’. In step 743, the BS includes the UL_MAP IE for BW request/periodic ranging in the UL_MAP message. In step 747, the BS sets a bit value of the UL_MAP IE Existence for BW Request/Periodic Ranging field of the DLFP information to ‘1’. The reason for setting UL_MAP IE Existence for BW Request/Periodic Ranging=1 and Allocation or Change for BW Request/Periodic Ranging=0 is for the MSS that fails in recognizing the BW request/periodic ranging region information. An MSS previously recognizing the BW request/periodic ranging region information, rather than the MSS having no BW request/periodic ranging region information, recognizes that the BW request/periodic ranging region of the previous uplink frame is equal in position and size to the BW request/periodic ranging region of the current uplink frame, upon receiving the DLFP information specified with ‘10’. Therefore, the MSS has no need to decode the UL_MAP IE of the UL_MAP message.

In step 739, the BS sets a bit value of the Allocation or Change for BW Request/Periodic Ranging field of the DLFP information to ‘1’. Thereafter, in step 743, the BS includes the UL_MAP IE for BW request/periodic ranging in the UL_MAP message. In step 747, the BS sets a bit value of the UL_MAP IE Existence for BW Request/Periodic Ranging field of the DLFP information to ‘1’. The reason for setting UL_MAP IE Existence for BW Request/Periodic Ranging=1 and Allocation or Change for BW Request/Periodic Ranging=1 is to inform MSSs that there is a change in position and size between the BW request/periodic ranging region of the uplink frame and the BW request/periodic ranging region of the previous uplink frame. Therefore, upon receiving the DLFP information, all MSSs decode UL_MAP IE information in the UL_MAP message to perform an update of the BW request/periodic ranging information.

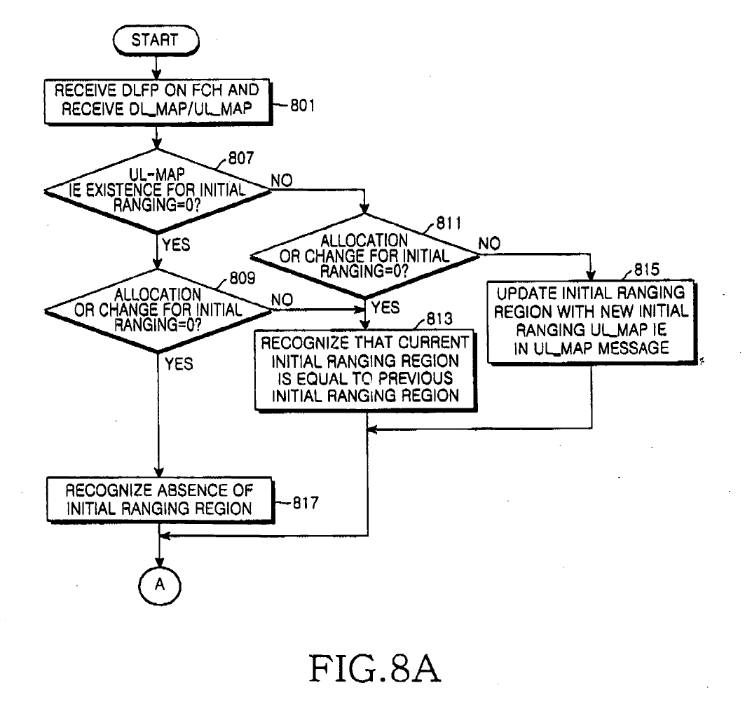

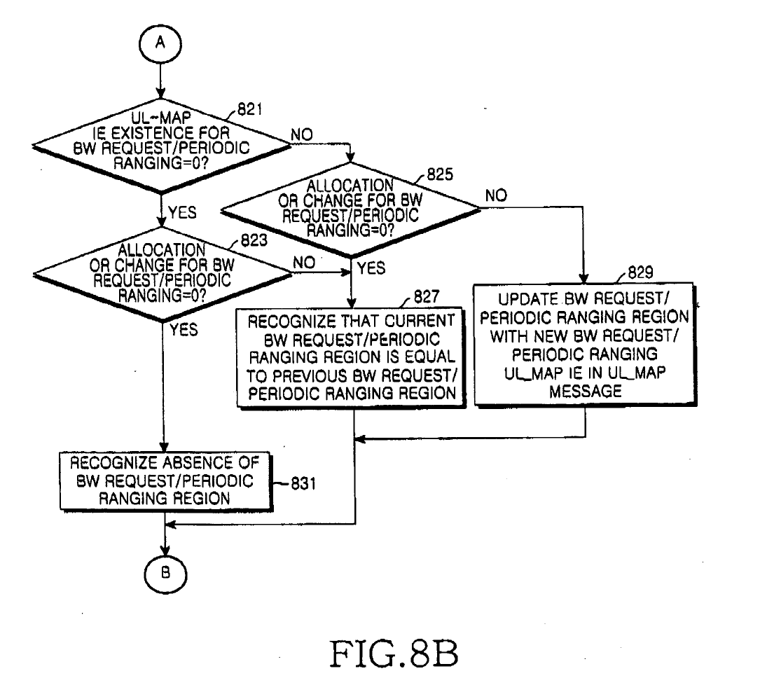

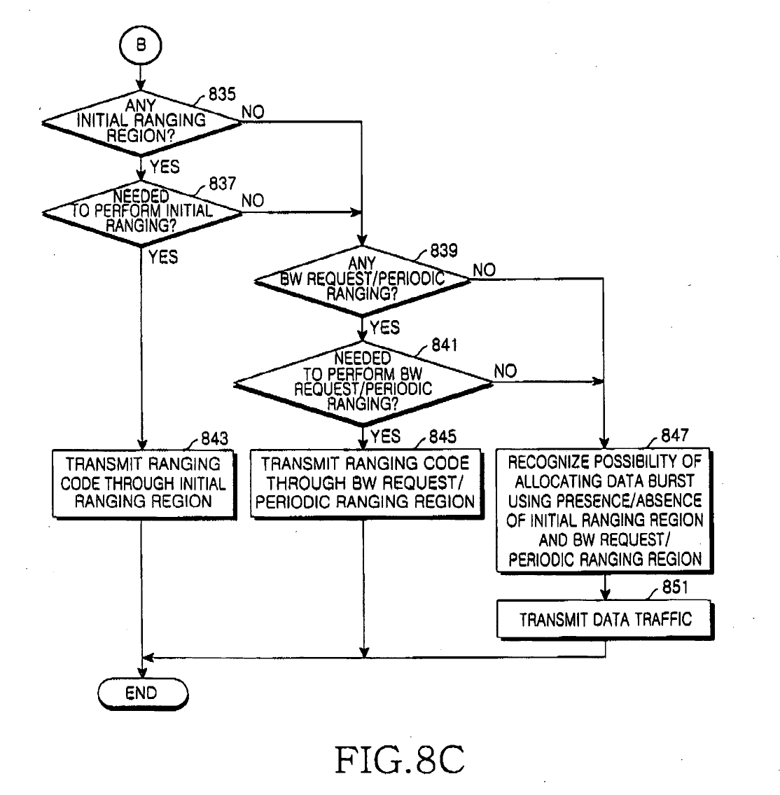

FIGS. 8A to 8C are flowcharts illustrating a process of recognizing a ranging region and performing the corresponding ranging in an MSS according to the present invention.

Referring to FIG. 8A, in step 801, the MSS receives DLFP information through a FCH region of a downlink frame, a DL_MAP message through a DL_MAP region, and a UL_MAP message through a UL_MAP region. In step 807, the MSS determines whether a bit value of a UL_MAP IE Existence for Initial Ranging field in the DLFP information is ‘0’. If the bit value is ‘0’, the MSS proceeds to step 809, and if the bit value is ‘1’, the MSS proceeds to step 811. In step 809, the MSS determines whether a bit value of an Allocation or Change for Initial Ranging field in the DLFP information is ‘0’. If the bit value is ‘0’, the MSS proceeds to step 817, and if the bit value is ‘1’, the MSS proceeds to step 813. In step 817, the MSS recognizes the absence of a UL_MAP IE for initial ranging in the UL_MAP message and the absence of an initial ranging region in the uplink frame, and then proceeds to step 821 of FIG. 8B.

In step 811, the MSS determines whether a bit value of the Allocation or Change for Initial Ranging field in the DLFP information is ‘0’. If the bit value is ‘0’, the MSS proceeds to step 813, and if the bit value is ‘1’, the MSS proceeds to step 815.

In step 813, the MSS recognizes that an initial ranging region is allocated in the current uplink frame and the initial ranging region is identical in position and size to the initial ranging region of the previous uplink frame.

In step 815, the MSS updates the initial ranging region information according to the UL_MAP IE of the UL_MAP message, recognizing a change in the initial ranging region, and then proceeds to step 821 of FIG. 8B.

Referring to FIG. 8B, the MSS determines in step 821 whether a bit value of a UL_MAP IE Existence for BW Request/Periodic Ranging field in the DLFP information is ‘0’. If the bit value is ‘0’, the MSS proceeds to step 823, and if the bit value is ‘1’, the MSS proceeds to step 825. In step 823, the MSS determines whether a bit value of an Allocation or Change for BW Request/Periodic Ranging field in the DLFP information is ‘0’. If the bit value is ‘0’, the MSS proceeds to step 831, and if the bit value is ‘1’, the MSS proceeds to step 827. In step 831, the MSS recognizes the absence of a BW request/periodic ranging region in the current uplink frame.

In step 825, the MSS determines whether a bit value of the Allocation or Change for BW Request/Periodic Ranging field in the DLFP information is ‘0’. If the bit value is ‘0’, the MSS proceeds to step 827, and if the bit value is ‘1’, the MSS proceeds to step 829.

In step 827, the MSS recognizes that a BW request/periodic ranging region is allocated in the current uplink frame and the BW request/periodic ranging region is identical in position and size to the BW request/periodic ranging region of the previous uplink frame.

In step 829, the MSS updates the BW request/periodic ranging region information according to the UL_MAP IE of the UL_MAP message, recognizing a change in the BW request/periodic ranging region, and then proceeds to step 835 of FIG. 8C.

Referring to FIG. 8C, there is provided a process of performing ranging by the MSS. In step 835, the MSS can determine whether there is an initial ranging region in the uplink frame by reading ranging indication information in the DLFP information, i.e., reading each bit value of a UL_MAP IE Existence for Initial Ranging field, an Allocation or Change for Initial Ranging field, a UL_MAP IE Existence for BW Request/Periodic Ranging field, and an Allocation or Change for BW Request/Periodic Ranging field. If there is an initial ranging region, the MSS proceeds to step 837, and if there is no initial ranging region, the MSS proceeds to step 839. In step 837, the MSS determines whether there is a need to perform initial ranging. If there is a need to perform initial ranging, the MSS proceeds to step 843, and if there is no need to perform initial ranging, the MSS proceeds to step 839.

In step 843, the MSS, as it is aware of the presence of the initial ranging region and the position and size of the initial ranging region, transmits a ranging code to the BS through the initial ranging region of the uplink frame to attempt the initial ranging.

In step 839, the MSS determines whether there is a BW request/periodic ranging region in the uplink frame. If there is a BW request/periodic ranging region, the MSS proceeds to step 841, and if there is no BW request/periodic ranging region, the MSS proceeds to step 847.

In step 841, the MSS determines whether there is a need to perform BW request/periodic ranging. If there is a need to perform BW request/periodic ranging, the MSS proceeds to step 845, and if there is no need to perform BW request/periodic ranging, the MSS proceeds to step 847.

In step 845, the MSS transmits a ranging code to the BS through the previously recognized BW request/periodic ranging region of the uplink frame, to attempt BW request/periodic ranging.

In step 847, after completion of the initial ranging and the BW request/periodic ranging, the MSS recognizes that it can allocate uplink data bursts in the remaining regions except for the initial ranging region and the BW request/periodic ranging region in the uplink frame. Thereafter, in step 851, the MSS transmits data traffic through the data burst allocation region.

The ranging region allocation method according to the first embodiment of the present invention has been described so far.

Next, a description will now be made of a ranging region allocation method for reducing a size of a UL_MAP message by excluding a UL_MAP IE with UIUC=12 in the UL_MAP message according to a second embodiment of the present invention.

### Second Embodiment

The second embodiment provides a scheme in which an MSS can perform ranging through a ranging region previously allocated in an uplink frame, even without including a UL_MAP IE with UIUC=12 in the UL_MAP message.

Downlink Frame Prefix (DLFP)

The DLFP is transmitted through a FCH region as described with reference to Table 1. A format of the DLFP information of the second embodiment of the present invention is shown in Table 7 below.

TABLE 7

| Syntax | Size | Notes |
|---|---|---|
| DL_Frame_Prefix_Format ( ) { | | |
| Used subchannel bitmap | 6 bits | Bit #0: Subchannels |
| | | 0-11 are used |
| | | Bit #1: Subchannels |
| | | 12-19 are used |
| | | Bit #2: Subchannels |
| | | 20-31 are used |
| | | Bit #3: Subchannels |
| | | 32-39 are used |
| | | Bit #4: Subchannels |
| | | 40-51 are used |
| | | Bit #5: Subchannels |
| | | 52-59 are used |
| Ranging_Change_Indication | 1 bit | |
| Initial Ranging_Change_Indication | 1 bit | |
| Repetition_Coding_Indication | 2 bits | 00 - No repetition coding |
| | | on DL_MAP |
| | | 01 - repetition coding |
| | | of 2 used on DL_MAP |
| | | 10 - repetition coding |
| | | of 4 used on DL_MAP |
| | | 11 - repetition coding |
| | | of 6 used on DL_MAP |
| Coding_Indication | 3 bits | 0b000 - CC encoding |
| | | used on DL_MAP |
| | | 0b001 - BTC encoding |
| | | used on DL_MAP |
| | | 0b010 - CTC encoding |
| | | used on DL_MAP |
| | | 0b011 - ZT CC used on |
| | | DL_MAP |
| | | 0b100 to 0b111 - |
| | | Reserved |
| DL_MAP_Length | 8 bit | |
| Reserved } | 3 bits | |

The DLFP information, as described above, is transmitted through the FCH region. The present invention can use one of the 4 reserved bits of the conventional DLFP information shown in Table I for an Initial Ranging_Change_Indication field which is similar to the Ranging Change Indication field. The other fields are equal to those in Table 1 and Table 6, so a description thereof will be omitted.

Similarly to the Ranging_Change_Indication bit, the Initial Ranging_Change_Indication bit of the second embodiment of the present invention, like indicates a change in position or size of an initial ranging region and de-allocation of the initial ranging region through comparison between the previous uplink frame and the current uplink frame. In other words, if there is a change in the initial ranging region, the BS includes a new initial ranging UL_MAP IE in the UL_MAP message and sets the Initial Ranging_Change_Indication bit in the DLFP information to ‘1’.

When an initial ranging region is newly allocated in the uplink frame, the BS includes an initial ranging UL_MAP IE in the UL_MAP message and sets the Initial Ranging_Change_Indication bit in the DLFP information to ‘1’. If there is the same initial ranging region in the next uplink frame, the BS sets the Initial Ranging_Change_Indication bit in the DLFP information to ‘0’ and includes no initial ranging UL_MAP IE in the UL_MAP message. The Initial Ranging_Change_Indication bit value is continuously maintained until there is a change in the initial ranging region or there is no initial ranging region included in the uplink frame.

If the initial ranging region is not allocated, the BS sets the Initial Ranging_Change_Indication bit in the DLFP information to ‘1’ to indicate the change in the initial ranging region, and includes no initial ranging UL_MAP IE in the UL_MAP message.

To perform initial ranging, an MSS must detect the Initial Ranging_Change_Indication bit. That is, an MSS intending to attempt initial ranging must wait until it first receives DLFP information with Initial Ranging_Change_Indication bit=‘1’, during network entry attempt. Upon first receiving the DLFP information with Initial Ranging_Change_Indication bit=‘1’, the MSS determines whether there is an initial ranging UL_MAP IE with UIUC=12 in the UL_MAP message. If it is determined that there is the initial ranging UL_MAP IE, the MSS recognizes the presence of the initial ranging region in the uplink frame, and transmits a ranging code through the recognized initial ranging region.

However, if there is no initial ranging UL_MAP IE in the UL_MAP message, the MSS cannot transmit the ranging code because there is no initial ranging region in the uplink frame. Therefore, the MSS must delay its transmission of the ranging code until it receives DLFP information with Initial Ranging_Change_Indication bit=‘1’ indicating the frame in which an initial ranging region is allocated.

The MSSs not performing the initial ranging, i.e., the MSSs regularly receiving a service by correctly performing a network entry procedure with the BS, should continuously recognize a change in the bit value of the Ranging_Change_Indication field and the Initial Ranging_Change_Indication field, to determine whether there is a BW request/periodic ranging region or an initial ranging region allocated in the uplink frame, and should be aware of the data burst allocation region according thereto.

The BS may randomly include an initial ranging UL_MAP IE in the UL_MAP message periodically or when necessary, for the MSS that fails in recognizing initial ranging region information. As a result, an initial ranging region may be allocated in the uplink frame periodically or randomly.

When the ranging region allocation and indication operation scheme proposed in the present invention is applied to a Broadband Wireless Access (BWA) communication system, there might be MSSs that cannot perform the operation scheme. In other words, when there is no initial ranging UL_MAP IE or BW request/periodic ranging UL_MAP IE in the UL_MAP message, the MSS can recognize that no ranging region is allocated, as described in the prior art section. In this case, the BS may allocate no data burst to the MSSs that cannot perform the operation proposed in the present invention, when a bit value of the UL_MAP IE Existence for Initial Ranging field is ‘0’, i.e., when there is no UL_MAP IE in the UL_MAP message, even though a bit value of the Allocation or Change for Initial Ranging field is ‘1’, i.e., even though there is a ranging region in the uplink frame.

That is, the BS does not allocate Connection IDs (CIDs) of MSSs that cannot perform the operation scheme proposed in the present invention, to a CID field of a UL_MAP IE with UIUC=1 to UIUC=11 of the UL_MAP message or a UL_MAP IE with UIUC=15. In this manner, the present invention can also be applied to the system including MSSs that cannot support the ranging region proposed by the present invention.

### Third Embodiment

A DLFP format of the third embodiment of the present invention is the same as the conventional DLFP format shown in Table 1. However, while the Ranging_Change_Indication field in the DLFP format shown in Table 1 indicates a change in allocation of a BW request/periodic ranging region, the Ranging_Change_Indication field in the DLFP format proposed in the third embodiment indicates a change in allocation of the BW request/periodic ranging region or a change in allocation of an initial ranging region as well.

That is, if a bit value of the Ranging_Change_Indication field is ‘0’ in the conventional DLFP format of Table 1, it means that the BW request/periodic ranging region of the previous frame is identical to the BW request/periodic ranging region of the current frame. In addition, if a bit value of the Ranging_Change_Indication field is ‘1’ in the conventional DLFP format of Table 1, it means that the BW request/periodic ranging region of the previous frame is different from the BW request/periodic ranging region of the current frame.

However, if a bit value of the Ranging_Change_Indication field is ‘0’ in the DLFP format according to the third embodiment, it means that the BW request/periodic ranging region or the initial ranging region of the previous frame is identical to the BW request/periodic ranging region or the initial ranging region of the current frame. In addition, if a bit value of the Ranging_Change_Indication field is ‘1’ in the DLFP format according to the third embodiment, it means that the BW request/periodic ranging region or the initial ranging region of the previous frame is different from the BW request/periodic ranging region or the initial ranging region of the current frame.

Therefore, in the third embodiment of the present invention, the bit value of the Ranging_Change_Indication field is set to ‘1’ in the following three cases.

First, the bit value of the Ranging_Change_Indication field is set to ‘1’ when there is a change in position between the BW request/periodic ranging region allocated in the previous uplink frame and the BW request/periodic ranging region allocated in the current uplink frame, or when the BW request/periodic ranging region allocated in the current frame is de-allocated in the next frame or vice versa.

Second, the bit value of the Ranging_Change_Indication field is set to ‘1’ when there is a change in position between the initial ranging region allocated in the previous uplink frame and the initial ranging region allocated in the current uplink frame, or when the initial ranging region allocated in the current frame is de-allocated in the next frame or vice versa.

Third, the bit value of the Ranging_Change_Indication field can be set to ‘1’ when at least one of the above two conditions occurs in the case where both the first and second situations are satisfied.

When one of the foregoing 3 conditions is satisfied, the BS sets the bit value of the Ranging_Change_Indication field to ‘1’ and can perform the following operations.

For example, when allocating only the initial ranging region in the uplink frame in which no BW request/periodic ranging region and initial ranging region is allocated, the BS sets the Ranging_Change_Indication field to ‘1’, and includes only the UL_MAP IE for initial ranging in the UL_MAP message because only the initial ranging region is allocated in the current uplink frame.

As another example, when there is a change in allocation or position of the BW request/periodic ranging region between the previous uplink frame and the current uplink frame, the BS sets the Ranging_Change_Indication field to ‘1’ and includes the UL_MAP IE for BW request/periodic ranging in the UL_MAP message.

In addition, when there is a change in region itself or allocation for both the initial ranging region and the BW request/periodic ranging region, the BS sets the Ranging_Change_Indication field to ‘1’ and includes the UL_MAP IE for initial ranging and the UL_MAP IE for BW request/periodic ranging in the UL_MAP message.

Moreover, there is a possible case where the initial ranging region out of the BW request/periodic ranging region and the initial ranging region allocated in the previous uplink frame is de-allocated in the current uplink frame, so only the BW request/periodic ranging region is allocated. In this case, because the BW request/periodic ranging region is still allocated in the uplink frame, the UL_MAP message must continue to include the UL_MAP IE for BW request/periodic ranging.

Even in the case where the BW request/periodic ranging region and the initial ranging region allocated in the previous uplink frame are both de-allocated in the current uplink frame so there is no BW request/periodic ranging region and initial ranging region, the BS sets the Ranging_Change_Indication field to ‘1’ because there is a change in allocation of the ranging region. However, there is no UL_MAP IE with UIUC=12 in the UL_MAP message.

Summarizing, when there is a change in any one of the BW request/periodic ranging region and the initial ranging region, the BS sets the Ranging_Change_Indication field in the DLFP to ‘1’, determines whether to include the UL_MAP IE according to the change result, and generates the UL_MAP message according thereto.

When the bit value of the Ranging Change Indication field in the DLFP is ‘1’, the MSS determines whether there are an initial ranging UL_MAP IE and a BW request/periodic ranging UL_MAP IE in the UL_MAP message of the corresponding uplink frame, to detect ranging region allocation information from the uplink frame. An MSS first attempting network entry waits until it receives a DLFP with Ranging_Change_Indication bit=‘1’. Upon receiving the DLFP with Ranging_Change_Indication bit=‘1’, the MSS determines whether there is an initial ranging UL_MAP IE with UIUC=12 in the UL_MAP message.

If there is the initial ranging UL_MAP IE in the UL_MAP message, the MSS recognizes the presence of the initial ranging region in the uplink frame. Therefore, the MSS can attempt initial ranging by transmitting a ranging code through the recognized initial ranging region. However, if there is no initial ranging UL_MAP IE in the UL_MAP message, the MSS recognizes the absence of the initial ranging region in the uplink frame. Therefore, the MSS cannot attempt the ranging, and waits for the transmission of the ranging code until it receives the next DLFP with Ranging_Change_Indication bit=‘1’.

Among the MSSs not performing the initial ranging, the MSS intending to perform a BW request/periodic ranging operation must wait until it first receives the DLFP with Ranging_Change_Indication bit=‘1’. Upon first receiving the DLFP with Ranging_Change_Indication bit=‘1’, the MSS determines whether there is a BW request/periodic ranging UL_MAP IE with UIUC=12 in the UL_MAP message. If it is determined that there is the BW request/periodic ranging UL_MAP IE in the UL_MAP message, the MSS recognizes that the initial ranging region is allocated in the uplink frame. Therefore, the MSS transmits a ranging code for BW request/periodic ranging through the BW request/periodic ranging region. However, if there is no UL_MAP IE for BW request/periodic ranging in the UL_MAP message, the MSS waits for the transmission of the ranging code until it receives the next DLFP with Ranging_Change_Indication bit=‘1’.

However, the MSSs regularly communicating with the BS should continue to detect a change in bit value of the Ranging_Change_Indication field, and determine whether the BW request/periodic ranging region or the initial ranging region is allocated in the uplink frame and whether there is a change in the BW request/periodic ranging region or the initial ranging region. Based on the determination result, the MSS should be aware that data bursts are allocated in the other regions remaining in the uplink frame.

Therefore, the BS can randomly include both or any one of the initial ranging UL_MAP IE and the BW request/periodic ranging UL_MAP IE in the UL_MAP message periodically or when necessary, for the MS that fails in recognizing initial ranging information or the MSS that fails in recognizing the BW request/periodic ranging information. As a result, the uplink frame can include therein the initial ranging region and the BW request/periodic ranging region separately or together on a periodic or random basis.

As can be understood from the foregoing description, the present invention adaptively excludes ranging region allocation information included in the broadcast message that must be transmitted every frame, contributing to a reduction in message overhead. The reduction in the message overhead can increase the bandwidth transmission efficiency, and the MSS, when it previously recognizes the same ranging region information, has no need to decode the broadcast message unnecessarily, contributing to a reduction in signal processing load.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for allocating and indicating a ranging region by a base station (BS) in a broadband wireless access (BWA) communication system, the method comprising the steps of:
including ranging region allocation and change indication information in a first region of every downlink frame; and
determining whether to include information necessary for performing ranging in a broadcast message that is broadcast through a second region of every downlink frame according to the ranging region allocation and change indication information.

2. The method of claim 1, wherein the first region includes a frame control header (FCH) region.

3. The method of claim 1, wherein the ranging region allocation and change indication information includes at least one of UL_MAP IE Existence for Initial Ranging information indicating a presence and/or absence of initial ranging information in an uplink MAP (UL_MAP) message representative of the broadcast message, Allocation or Change for Initial Ranging information indicating allocation or change for an initial ranging region between a previous uplink frame and a current uplink frame, UL_MAP IE Existence for BW Request/Periodic Ranging information indicating a presence and/or absence of bandwidth (BW) request/periodic ranging information in the UL_MAP message, and an Allocation or Change for BW Request/Periodic Ranging information indicating an allocation or a change for a BW request/periodic ranging region between the previous uplink frame and the current uplink frame.

4. The method of claim 1, wherein the ranging region allocation and change indication information includes Initial Ranging_Change_Indication information indicating an allocation or a change for an initial ranging region between a previous uplink frame and a current uplink frame.

5. The method of claim 1, wherein the ranging region allocation and change indication information includes Ranging_Change_Indication information indicating an allocation or a change for an initial ranging region and a BW request/periodic ranging region between a previous uplink frame and a current uplink frame.

6. The method of claim 5, wherein the Ranging_Change_Indication information includes information indicating that a ranging region of the current uplink frame is different from a ranging region of the previous uplink frame when at least one of the initial ranging region and the BW request/periodic ranging region is allocated or changed.

7. The method of claim 1, wherein the ranging region allocation and change indication information is included in downlink frame prefix (DLFP) information that is transmitted through the first region.

8. The method of claim 1, wherein the second region includes a UL_MAP region.

9. The method of claim 1, further comprising:
determining whether to include information necessary for performing ranging in the broadcast message;
allocating a ranging region in the uplink frame according to the determination result; and
indicating an allocation and a change for the ranging region in the broadcast message.

10. A method for performing ranging by a mobile subscriber station (MSS) in a broadband wireless access (BWA) communication system, the method comprising the steps of:
receiving ranging region allocation and change indication information included in a first region of every downlink frame;
determining whether to read information necessary for performing ranging from a broadcast message that is broadcast through a second region of every downlink frame according to the ranging region allocation and change indication information;
recognizing a ranging region of an uplink frame according to the determination result; and
performing ranging through the recognized ranging region.

11. The method of claim 10, wherein the first region includes a frame control header (FCH) region.

12. The method of claim 10, wherein the ranging region allocation and change indication information includes at least one of a UL_MAP IE Existence for Initial Ranging information indicating a presence or an absence of initial ranging information in an uplink MAP (UL_MAP) message, Allocation or Change for Initial Ranging information indicating allocation or change for an initial ranging region between a previous uplink frame and a current uplink frame, UL_MAP IE Existence for BW Request/Periodic Ranging information indicating a presence or an absence of bandwidth (BW) request/periodic ranging information in the UL_MAP message, and Allocation or Change for BW Request/Periodic Ranging information indicating an allocation or a change for a BW request/periodic ranging region between the previous uplink frame and the current uplink frame.

13. The method of claim 10, wherein the ranging region allocation and change indication information includes Initial Ranging_Change_Indication information indicating an allocation or a change for an initial ranging region between a previous uplink frame and a current uplink frame.

14. The method of claim 10, wherein the ranging region allocation and change indication information includes Ranging_Change_Indication information indicating an allocation or a change for an initial ranging region and a BW request/periodic ranging region between a previous uplink frame and a current uplink frame.

15. The method of claim 14, wherein the Ranging_Change_Indication information includes information indicating that a ranging region of the current uplink frame is different from a ranging region of the previous uplink frame when at least one of the initial ranging region and the BW request/periodic ranging region is allocated or changed.

16. The method of claim 10, wherein the ranging region allocation and change indication information is included in downlink frame prefix (DLFP) information that is transmitted through the first region.

17. The method of claim 10, wherein the second region includes a UL_MAP region.

18. A method for allocating a ranging region and performing ranging by a base station (BS) and a mobile subscriber station (MSS) in a broadband wireless access (BWA) communication system, the method comprising the steps of:
including, by the BS, ranging region allocation and change indication information in a first region of every downlink frame;
determining, by the BS, whether information necessary for performing ranging is included in a broadcast message that is broadcast through a second region of every downlink frame according to the ranging region allocation and change indication information;
allocating a ranging region in an uplink frame according to the ranging region allocation and change indication information;
transmitting, by the BS, the downlink frame to the MSS;
receiving, by the MSS, the ranging region allocation and change indication information included in the first region of every downlink frame;
determining, by the MSS, whether to read information necessary for performing ranging from a broadcast message that is broadcast through the second region of every downlink frame according to the ranging region allocation and change indication information;
recognizing, by the MSS, a ranging region of an uplink frame according to the determination result; and
performing, by the MSS, ranging through the recognized ranging region.

19. The method of claim 18, wherein the first region includes a frame control header (FCH) region.

20. The method of claim 18, wherein the ranging region allocation and change indication information includes at least one of UL_MAP IE Existence for Initial Ranging information indicating a presence or an absence of initial ranging information in an uplink MAP (UL_MAP) message, Allocation or Change for Initial Ranging information indicating an allocation or a change for an initial ranging region between a previous uplink frame and a current uplink frame, UL_MAP IE Existence for BW Request/Periodic Ranging information indicating an presence or an absence of bandwidth (BW) request/periodic ranging information in the UL_MAP message, and Allocation or Change for BW Request/Periodic Ranging information indicating an allocation or a change for a BW request/periodic ranging region between the previous uplink frame and the current uplink frame.

21. The method of claim 18, wherein the ranging region allocation and change indication information includes Initial Ranging_Change_Indication information indicating an allocation or a change for an initial ranging region between a previous uplink frame and a current uplink frame.

22. The method of claim 18, wherein the ranging region allocation and change indication information includes Ranging_Change_Indication information indicating an allocation or a change for an initial ranging region and a BW request/periodic ranging region between a previous uplink frame and a current uplink frame.

23. The method of claim 22, wherein the Ranging_Change_Indication information includes information indicating that a ranging region of the current uplink frame is different from a ranging region of the previous uplink frame when at least one of the initial ranging region and the BW request/periodic ranging region is allocated or changed.

24. The method of claim 18, wherein the ranging region allocation and change indication information is included in downlink frame prefix (DLFP) information that is transmitted through the first region.

25. The method of claim 18, wherein the second region includes a UL_MAP region.

26. A system for allocating a ranging region and performing ranging between a base station (BS) and a mobile subscriber station (MSS) in a broadband wireless access (BWA) communication system, the system comprising:
the BS for:
including ranging region allocation and change indication information in a first region of every downlink frame; determining whether information necessary for performing ranging is included in a broadcast message that is broadcast through a second region of every downlink frame according to the ranging region allocation and change indication information;
allocating a ranging region in an uplink frame according to the ranging region allocation and change indication information; and
transmitting the downlink frame to the MSS; and
the MSS for:
receiving from the BS the ranging region allocation and change indication information included in the first region of every downlink frame;
determining whether to read information necessary for performing ranging from a broadcast message that is broadcast through the second region of every downlink frame according to the ranging region allocation and change indication information;
recognizing a ranging region of an uplink frame according to the determination result; and
performing ranging through the recognized ranging region.

27. The system of claim 26, wherein the first region includes a frame control header (FCH) region.

28. The system of claim 26, wherein the ranging region allocation and change indication information includes at least one of UL_MAP IE Existence for Initial Ranging information indicating a presence or an absence of initial ranging information in an uplink MAP (UL_MAP) message, Allocation or Change for Initial Ranging information indicating allocation or change for an initial ranging region between a previous uplink frame and a current uplink frame, UL_MAP IE Existence for BW Request/Periodic Ranging information indicating a presence or an absence of bandwidth (BW) request/periodic ranging information in the UL_MAP message, and Allocation or Change for BW Request/Periodic Ranging information indicating an allocation or a change for a BW request/periodic ranging region between the previous uplink frame and the current uplink frame.

29. The system of claim 26, wherein the ranging region allocation and change indication information includes Initial Ranging_Change_Indication information indicating an allocation or a change for an initial ranging region between a previous uplink frame and a current uplink frame.

30. The system of claim 26, wherein the ranging region allocation and change indication information includes Ranging_Change_Indication information indicating an allocation or a change for an initial ranging region and a BW request/periodic ranging region between a previous uplink frame and a current uplink frame.

31. The system of claim 30, wherein the Ranging_Change_Indication information includes information indicating that a ranging region of the current uplink frame is different from a ranging region of the previous uplink frame when at least one of the initial ranging region and the BW request/periodic ranging region is allocated or changed.

32. The system of claim 26, wherein the ranging region allocation and change indication information is included in downlink frame prefix (DLFP) information that is transmitted through the first region.

33. The system of claim 26, wherein the second region includes a UL_MAP region.
